(19) United States
(12) Patent Application Publication
(10) Pub. No.: US 2014/0069237 A1
(43) Pub. Date: Mar. 13, 2014

(54) Universal Spare Tire Release Tool Kit

(71) Applicant: Aurelio A. Vigil, Miami, FL (US)

(72) Inventor: Aurelio A. Vigil, Miami, FL (US)

(21) Appl. No.: 13/609,728

(22) Filed: Sep. 11, 2012

(51) Int. Cl. B25B 13/06

(52) U.S. Cl. 81/124.4

(57) ABSTRACT

A tool kit for operating any one of a plurality of different underchassis spare tire storage systems for motor vehicles which operate by lowering to make a stored spare tire manually accessible. The tool kit comprises a cranked manual handle, at least one extension for modularly varying effective length of the tool, and a plurality of sockets for engaging the terminus of the drive system of many different motor vehicles having underchassis spare tire storage systems.

### FIELD OF THE INVENTION

The present invention relates to tools, and more particularly, to a kit of tools which may be used to drive the under-chassis spare tire storage system of any one of many vehicles having an under-chassis spare tire storage system which may be lowered from the chassis to make a spare tire accessible for tire replacement.

### BACKGROUND OF THE INVENTION

Many motor vehicles have spare tires which are held on carriages below the body or chassis. This is typical for example in vehicles popularly known as Sports Utility Vehicles (SUVs). The carriage is ordinarily held close to the body or chassis, where it and the spare tire are held up away from the ground so as not to present a hazard of contacting the ground, road, or objects located on the ground or road.

When the need arises to gain access to the spare tire, the spare tire may be made accessible by lowering the carriage. This is typically done by operating a screw type drive which causes the carriage to lower from the chassis or body. The spare tire, which is typically a tire mounted on a wheel or rim, to be retrieved for installation on an axle in place of a presumably damaged or defective road wheel, which is also a tire mounted on a wheel or rim.

Operating the drive is usually performed by inserting a drive tool, such as a tool having a socket, a shaft, and a cranked handle, into engagement with a terminus of the drive, and manually rotating the tool and drive.

Motor vehicles having such drives are usually provided with a suitable tool to operate the drive. While this is satisfactory for the owner or operator of the vehicle, it can present problems for automotive service personnel who may have to service any one or more of many types of vehicles. For one thing, the original tool provided with the vehicle being serviced may be lost, placed within the vehicle in a location different from that intended by the manufacturer of the vehicle, may be rendered inaccessible by cargo and other materials loaded into the vehicle by the operator, or may be inaccessible for still other reasons.

The automotive service establishment remains in need of a modular tool which may be counted on to operate the drive of a system for storing a spare tire, and which is adaptable to serve most if not all of the many different systems of the many different motor vehicles provided with such a system.

### SUMMARY OF THE INVENTION

The present invention addresses the above stated need by providing a versatile tool which can operate the drive system of an underchassis spare tire storage system. The tool has modular replaceable components which enable a plurality of sockets or working heads to be removably attached, and to vary effective length of the tool. At a minimum, the tool comprises a cranked handle and an attachable socket for engaging a square drive or similar component of the drive system of the vehicle. Preferably provided as a kit, the tool comprises a plurality of components including different attachable sockets for accommodating square and other drives, and at least one extension for adapting the effective length of the assembled tool.

It is an object of the invention to provide a tool which operates the drive system of an underchassis spare tire storage system.

Another object of the invention is to accommodate connection requirements of drive systems of different underchassis spare tire storage systems.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a plan view of a modular tool kit according to at least one aspect of the invention.

FIG. 2 is a cross sectional side view of a handle member of the tool kit of FIG. 1.

FIG. 3 is an end detail view of the left end of FIG. 2.

FIG. 4 is a cross sectional side view of a socket member of the tool kit of FIG. 1.

FIG. 5 is an end view of the left end of FIG. 4.

FIG. 6 is an end view of an alternative left end of FIG. 4.

FIG. 7 is a broken away cross sectional side view of another socket member of the tool kit of FIG. 1.

FIG. 8 is an end view of the left end of FIG. 7.

FIG. 9 is an end view of the right end of FIG. 7.

FIG. 10 is a side view of another socket member of the tool kit of FIG. 1, and is shown partially in cross section.

FIG. 11 is a side view of still another socket member of the tool kit of FIG. 1, and is shown partially in cross section.

FIG. 12 is a side view of FIG. 11, with the subject matter rotated ninety degrees about the longitudinal axis from the view of FIG. 11.

FIG. 13 is an end view of FIG. 12.

FIG. 14 is a side view of yet another socket member of the tool kit of FIG. 1, and is shown partially in cross section.

FIG. 15 is a side detail view of FIG. 14, taken in mirror image, and is shown partially in cross section.

FIG. 16 is an end view of the left of FIG. 14.

FIG. 17 is a side view of yet another socket member of the tool kit of FIG. 1, and is shown partially in cross section.

### DETAILED DESCRIPTION

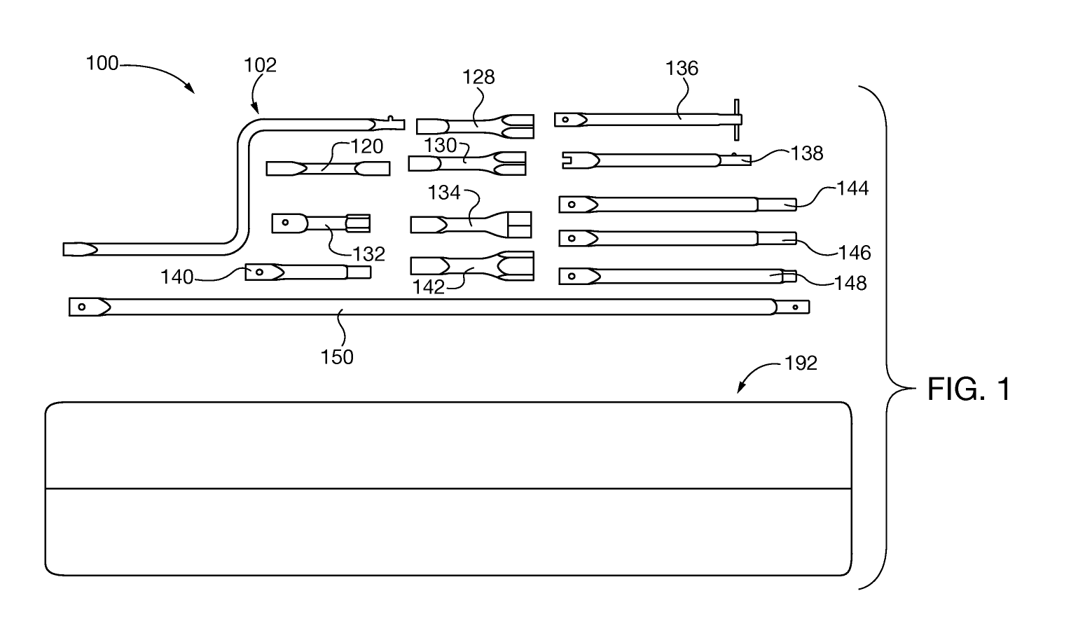

Referring first to FIG. 1, according to at least one aspect of the invention, there is shown a modular tool kit 100 for selective operating an underchassis spare tire storage system (not shown) for a motor vehicle, wherein the underchassis spare tire storage system operates by a mechanical linkage including a rotatably driven element which moves a carriage which holds the spare tire between a stowed position and an accessible position. The mechanical linkage is rotatably drivable by rotating a non-circular male or female member which must be engaged by a suitable hand tool. The modular tool kit 100 provides a suitable hand tool having a driver which is compatible with the non-circular male or female member, and provides a variety of sizes and configurations of such drivers to assure that the modular tool kit 100 will be usable with most if not all underchassis spare tire storage systems presently commercially offered by motor vehicle manufacturers.

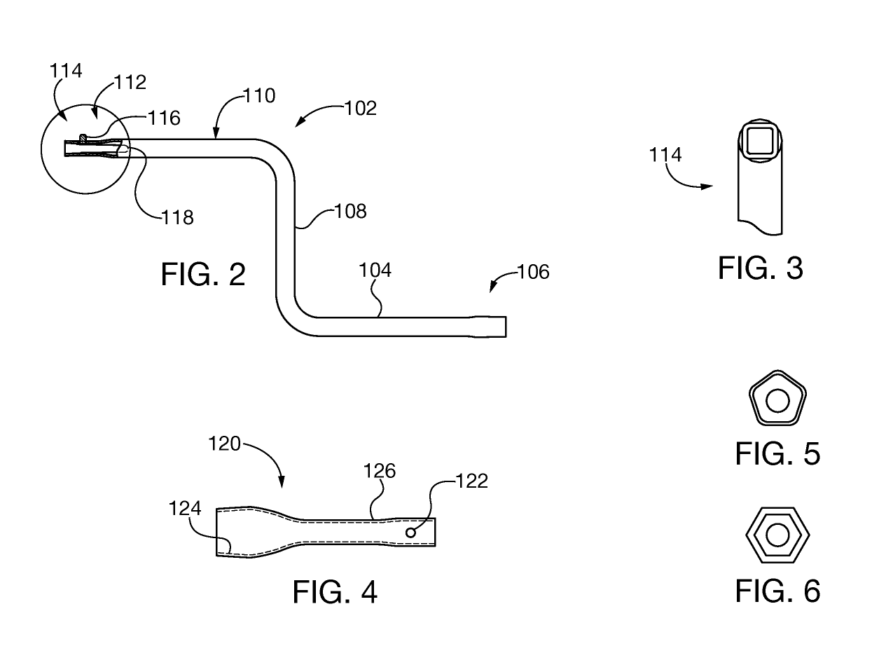

As seen in FIGS. 1 and 2, the modular tool kit 100 comprises a handle member 102 which is grasped by the user and rotated manually. This handle member 102 may directly drive an underchassis spare tire storage system or alternatively, may include a variety of wrenches and at least one extension to increase the reach of the handle member 102. As clearly seen in FIG. 2, the handle member 102 may comprise a hollow tubular straight drive shaft 104 having a distal end terminating in one non-circular connector 106 and a proximal end joined to a crank 108, and a handle 110 joined to the crank 108. The drive shaft 104 and the handle 110 are parallel to one another, being fixed in this relationship by the crank 108. The handle 110 may comprise a distal end forming another non-circular connector 112. The non-circular connector 112 may be utilized in a manner similar to that of the non-circular connector 106. This enables the drive shaft 104 and the handle 110 each to serve to drive a wrench or socket or an extension or both, and hence are interchangeable in function as handle and drive shaft.

The handle member 102 enables ready grasp and rotation of a modular wrench which may be coupled to the handle member 102. Wrenches will be referred to as socket members, although in some implementations, the wrenches will be different from typical sockets. FIG. 3 shows how the proximal end 114 may be formed to serve as either a female socket or as a driver. As clearly seen in FIG. 3, the cross sectional configuration of the tubing forming the handle 110, which may be circular along most of the length of the handle 110, is of square internal cross sectional configuration along its length, albeit as shown with rounded corners. This configuration enables the proximal end 114 to be used as a drive element such as a male square drive or as a female square socket, or as a connector for connecting an extension (to be described hereinafter).

Should the driven member of the underchassis spare tire storage system not be compatible with the drive element of the proximal end 114, a socket member providing the required size and configuration may be employed.

The handle 110 or an extension or socket member to be coupled to the handle 110 may include a manually releasable locking feature disposed to releasably lock the handle member to a socket member or extension. Preferably, the manually releasable locking feature comprises a hole formed in one of the handle member and the socket member, and a depressible pin which is associated with and movably fixed to the other of the handle member and the socket member. The depressible pin may occupy the hollow center of its associated handle member or socket member. In FIG. 2, a depressible pin 116 mounted to a U-shaped spring 118 occupies the hollow center of the handle 110. In this case, the handle 110 would be used with a socket member such as the socket member 120 seen in FIG. 4, which bears a hole 122 which is adapted to receive the depressible pin 116. The depressible pin projects from the handle 110 so as to engage and withdraw from the hole 122. The spring fixes the depressible pin 116 to the handle 110 and biases the pin into a position engaging the hole 122 to oppose casual unintended disconnection of the socket member 120 from the handle 110. The socket member 120 comprises a socket 124, which is enlarged compared to the tubular shaft 126 of the socket member 120. Preferably, the socket 124 makes a gradual transition at the junction with the tubular shaft 126. The socket 124 may be pentagonal, as seen in FIG. 5, hexagonal, as seen in FIG. 6, or square, as seen in FIG. 3, although FIG. 3 depicts the end of the handle 110.

The modular tool kit 100 preferably includes a plurality of socket members 120, 128, 130, 132, 134, 136, 138, 140, 142, which preferably each comprise a hollow tubular shaft such as the tubular shaft 126, a distal end comprising a drive element which is compatible with a corresponding rotatably driven element of one variety of commercial underchassis spare tire storage systems, and a proximal end comprising another non-circular connector which is matingly compatible with the non-circular connector of the handle member 102. Preferably, the socket members 120, 128, 130, 132, 134, 136, 138, 140, 142 include drive elements which are dimensioned and configured to be different from each other, and collectively are usable with the vast majority of commercial underchassis spare tire storage systems.

The modular tool kit 100 preferably comprises at least one straight extension such as the straight extensions 144, 146, 148, 150. Each straight extension preferably comprises a hollow shaft including a proximal end which is dimensioned and configured to be matingly compatible with the non-circular connector of the handle member 102 and a distal end which is dimensioned and configured to duplicate the non-circular connector of the handle member 102 so that the straight extension 144, 146, 148 or 150 may be inserted serially between the handle member 102 and a selected socket member 120, 128, 130, 132, 134, 136, 138, 140, or 142. This concept is widely practiced with conventional tools such as ratchet wrenches.

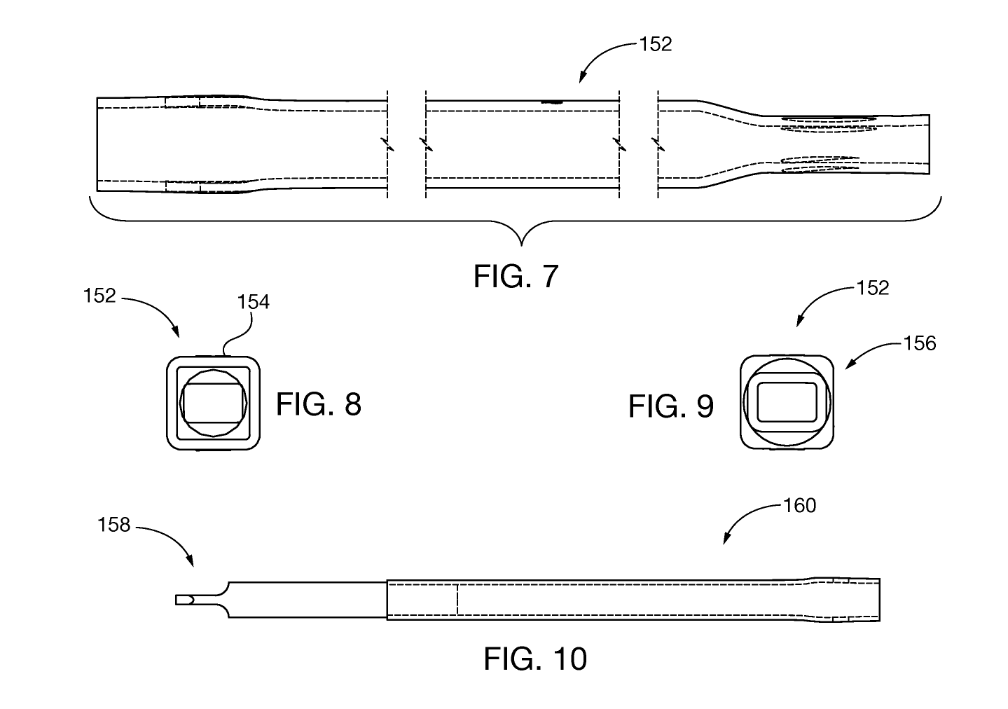

Another arrangement for a socket member 152 is seen in FIGS. 7-9. The socket member 152 may have a square drive 154 formed at one end for connection to the handle member 102 or to an extension such as any of extensions 144, 146, 148, 150. A rectangular drive 156 may be provided at the other end for driving purposes. The rectangular drive 156 may be a male driver which is inserted into a cooperating female socket (not shown) formed in the underchassis spare tire storage system for example.

Another variation on a rectangular driver is shown in FIG. 10. In the example of FIG. 10, the male drive connector 158 of a socket member 160 is rectangular in cross sectional configuration along its length, and is formed as a solid, filled component devoid of hollows or other internal voids. The male drive connector 160 may be received within the tube 162 of the socket member 160 and securely crimped thereby.

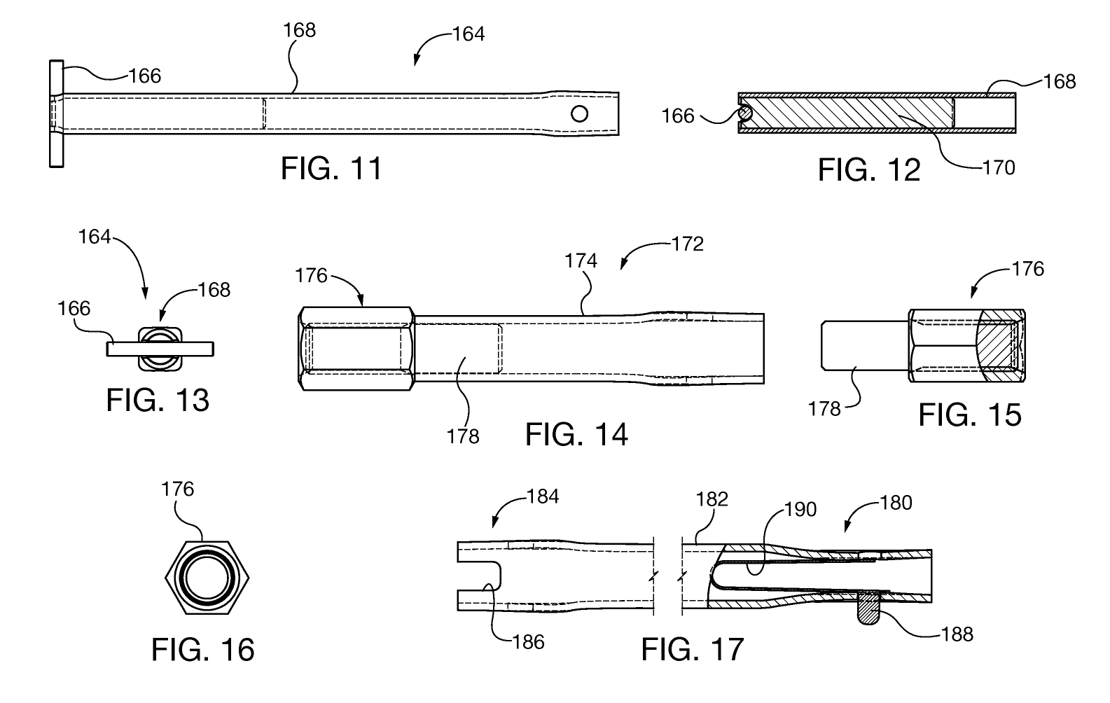

Turning now to FIGS. 11-13, a male drive connector 170 of a socket member 164 may include a pin 166 extending laterally from the longitudinal dimension of the drive shaft 168 of the socket member 164. The pin 166 may be fixed for example by welding to the male drive connector 170, which may be a solid, filled component devoid of hollows and other internal voids.

FIGS. 14-16 show a male drive connector 172 comprising a hollow, tubular drive shaft 174 and a male drive connector in the form of a hexagonal drive 176. The hexagonal drive 176 may be a solid, filled component devoid of hollows and other internal voids, as seen in FIG. 15. The hexagonal drive 176 may be fixed to the tubular drive shaft 174 by crimping the latter over the stub shaft 178 of the hexagonal drive 176. FIG. 16 clearly shows the hexagonal outer wrench surface of the hexagonal drive 176.

The hexagonal male drive connector 172 of FIGS. 14-16 may be contrasted with the socket 124 of FIG. 4 in that the socket 124 may be a female socket which receives a corresponding male driver.

Although the male drive connector 172 may be hexagonal as shown in FIGS. 14-16, it may also be pentagonal. A pentagonal shape is exemplified in FIG. 5 as a female socket. A solid male drive connector such as the male drive connector 172 may be modified to include a pentagonal outer wrench surface in place of the hexagonal shape shown in FIGS. 14-16.

FIG. 17 shows a socket member 180 comprising a drive shaft 182. A female socket 184 may comprise a slot 186 which is recessed into the female socket 184. The slot 186 may engage fingers or a pin (none shown) which may be formed in the drive mechanism of an underchassis spare tire storage system to rotate the linkage of the latter. That end of the socket member 180 opposite the slot 186 is seen to include a depressible pin 188 mounted on a spring 190 to facilitate connection to the handle member 102 or to an extension such as the extensions 144, 146, 148, 150.

Returning to FIG. 1, the modular tool kit 100 may comprise a flexible pouch 192 which is dimensioned and configured to receive and store the handle member 102, socket members such as the socket members 120, 128, 130, 132, 134, 136, 138, 140, 142, and extensions such as the extensions 144, 146, 148, 150. The pouch may be of plastic, leather, rubber, fabric, or other flexible material, and may include a drawstring or other fastening arrangement (none shown) to keep the pouch closed.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A modular tool kit for selective operating an underchassis spare tire storage system for a motor vehicle, wherein the underchassis spare tire storage system operates by a mechanical linkage including a rotatably driven element which moves a carriage which holds the spare tire between a stowed position and an accessible position, comprising:
a handle member comprising a hollow tubular straight drive shaft having a distal end terminating in a first non-circular connector and a proximal end joined to a crank, and a handle joined to the crank;
a plurality of socket members wherein each said socket member comprises a hollow tubular shaft further comprising a distal end comprising a drive element which is compatible with a corresponding rotatably driven element of one underchassis spare tire storage system and a proximal end comprising a second non-circular connector which is matingly compatible with the first non-circular connector, wherein the socket members include drive elements which are dimensioned and configured to be different from each other.

2. The modular tool kit of claim 1, further comprising a straight extension which further comprises a hollow shaft including a proximal end which is dimensioned and configured to be matingly compatible with the first non-circular connector, and a distal end which is dimensioned and configured to duplicate the first non-circular connector.

3. The modular tool kit of claim 1, further comprising a manually releasable locking feature disposed to releasably lock the handle member to a socket member.

4. The modular tool kit of claim 3, wherein the manually releasable locking feature comprises a hole formed in one of the handle member and the socket member, and a depressible pin which is
associated with and movably fixed to the other of the handle member and the socket member, wherein the depressible pin occupies the hollow center of its associated handle member or socket member;
projects from its associated handle member or socket member so as to engage and withdraw from the hole; and
comprises a spring which fixes the pin to its associated handle member or socket member and biases the pin into a position engaging the hole.

5. The modular tool kit of claim 1, wherein the drive shaft and the handle are parallel to one another, and the handle comprises a distal end forming a third non-circular connector, whereby the drive shaft and the handle each may serve to drive a socket and an extension, and hence are interchangeable in function as handle and drive shaft.

6. The modular tool kit of claim 1, wherein the first non-circular drive of the drive shaft of the socket member comprises a female socket.

7. The modular tool kit of claim 6, wherein the female socket has a wrench surface of square internal cross sectional configuration along its length.

8. The modular tool kit of claim 6, wherein the female socket has a wrench surface of hexagonal internal cross sectional configuration along its length.

9. The modular tool kit of claim 6, wherein the female socket has a wrench surface of pentagonal internal cross sectional configuration along its length.

10. The modular tool kit of claim 6, wherein the female socket has a wrench surface comprising a slot which is recessed into the female socket.

11. The modular tool kit of claim 1, wherein the non-circular drive of the socket member comprises a male drive connector.

12. The modular tool kit of claim 11, wherein the male drive connector is rectangular in cross sectional configuration along its length, and is formed by crimping the tube of the socket member to the male drive connector.

13. The modular tool kit of claim 11, wherein the male drive connector is a solid, filled component devoid of internal voids.

14. The modular tool kit of claim 11, wherein the male drive connector includes a pin extending laterally from the longitudinal dimension of the drive shaft.

15. The modular tool kit of claim 11, wherein the male drive connector comprises a hexagonal outer wrench surface.

16. The modular tool kit of claim 11, wherein the male drive connector comprises a pentagonal outer wrench surface.

17. The modular tool kit of claim 1, further comprising a flexible pouch which is dimensioned and configured to receive and store the handle member and the socket members therein.

18. The modular tool kit of claim 2, further comprising a flexible pouch which is dimensioned and configured to receive and store the handle member, the socket members, and the straight extension therein.
